(19) United States
(12) Patent Application Publication
(10) Pub. No.: US 2025/0047175 A1
(43) Pub. Date: Feb. 6, 2025

(54) TWO PHASE PCB STATOR MOTOR WITH INTEGRAL DRIVER CIRCUITRY

(71) Applicant: East West Manufacturing, LLC, Atlanta, GA (US)

(72) Inventors: Stephen Andrew Semidey, Woodstock, GA (US); Charles Simons, Peachtree Corners, GA (US); Ryan Lucas, Atlanta, GA (US); Ali Parsa-Sirat, Atlanta, GA (US); Belvin Freeman, Atlanta, GA (US); Ed Prather, Atlanta, GA (US)

(21) Appl. No.: 18/791,582

(22) Filed: Aug. 1, 2024

Related U.S. Application Data
(60) Provisional application No. 63/517,450, filed on Aug. 3, 2023.

(51) Int. Cl. H02K 11/33; H02K 1/12; H02K 11/04

(52) U.S. Cl. CPC H02K 11/33; H02K 1/12; H02K 11/04

(57) ABSTRACT

Driver circuits for a low-cost two-phase motor are disclosed. Cost reductions may be further achieved by utilizing a printed circuit board (PCB)-based stator and methods of manufacturing, as disclosed herein. The disclosed technology can be particularly well matched for use in two-phase motors, such as axial-flux motors the utilize one or more ferrite-based rotors and a printed circuit board (PCB)-based stator. In certain implementations, part or all of the motor driver circuitry may be integrated onto the same PCB as is utilized to define the stator windings. In other implementations, the motor driver circuitry may be independently utilized with other traditional electrical motors.

### CROSS-REFERENCE TO RELATED APPLICATIONS

This application claims the benefit of U.S. Provisional Application Ser. No. 63/517,450, filed on Aug. 3, 2023, the contents of which are incorporated herein by reference in its entirety as if fully set forth below.

### FIELD OF THE DISCLOSURE

The various embodiments of the present disclosure relate generally to driver circuitry for two-phase motors, which can have printed circuit board (PCB) stators. The driver circuitry may be integrated into the PCB to enable production of low-cost motors.

### BACKGROUND

The use of motors that utilize printed circuit board (PCB)-based stators has the potential to provide numerous advantages over conventional electrical motors that utilize a wire wound stator, which can be bulky and expensive to manufacture. However, typical PCB-based stators involve 3 phase motor designs. Little focus has been applied to smaller motor systems that use only one or two phases. However, there are many applications that could benefit from small, low-cost motors, that can be produced in high volumes.

A typical electrical motor includes a stator having multiple windings around a core that can be used to generate alternating magnetic field to interact with the rotor to provide the rotation. Among the challenges and drawbacks associated with traditional electrical motors is the reliance on copper wire windings and/or high magnetic density permanent magnets, such as rare earth elements like neodymium, which can lead to higher costs to achieve performance targets. Furthermore, traditional wire-based windings can be difficult and expensive to manufacture. For example, traditional stators are made using insulated windings mechanically wrapped around a core, which can introduce errors, increase costs, and limit the number of windings. Furthermore, small bending radii in the stator windings can increase the risk of electrical and/or mechanical failure.

Traditional motor driver circuitry utilized in electrical motors typically involves the use of H-bridges, complex timing firmware, and/or PWM circuitry that sequentially energizes the individual phases to induce a rotating magnetic field that can interact with poles of the rotor to cause the rotor to rotate. In applications that require precise angular positioning, a Hall sensor or other rotor positioning indication mechanism is typically utilized as feedback in a control circuit, such as a PID controller, to provide the proper drive signals to the stator windings. Such traditional drive circuitry can require additional control electronics, complex power supplies with isolated grounds, heat sinks, separate circuit boards, separate housings, additional wiring, etc., each of which can drive up the costs.

There are still needs for improved/simplified motor driver circuitry and manufacturing techniques that can utilize the benefits of the PCB-based stator while overcoming the challenges and expense associated with traditional designs.

### BRIEF SUMMARY

The disclosed technology relates to new motor driver designs that can address several of the previously mentioned shortcomings.

A two-phase motor driver circuit is disclosed herein. The circuitry can include a load terminal configured to connect with an alternating current (AC) load line; a neutral terminal connected to a ground, wherein the neutral terminal is further configured to connect with an AC neutral line; a first load rectifier having an anode and a cathode, wherein the anode is connected to the load terminal; a first load rectifier capacitor having a first end connected to the cathode of the first load rectifier and a second end connected to the ground; a second load rectifier having an anode and a cathode, wherein the cathode is connected to the load terminal; a second load rectifier capacitor having a first end connected to the anode of the second load rectifier and a second end connected to the ground; a first switching device having an input terminal, an output terminal, and a switching control terminal, wherein the input terminal is connected to the cathode of the first load rectifier; a second switching device having an input terminal, an output terminal, and a switching control terminal, wherein the input terminal is connected to the anode of the second load rectifier; a first motor terminal connected to the output terminal of the first switching device and the output terminal of the second switching device, wherein the first motor terminal is configured to connect with a first end of a first phase winding of a two-phase motor; a second motor terminal configured to connect with a first end of a second phase winding of the two-phase motor; a phase delay capacitor having a first end and a second end, wherein the first end is connected to the first motor terminal and the second end is connected to the second motor terminal; a third motor terminal connected to the ground and configured to connect to a second end of the first phase winding of the two-phase motor and a second end of the second phase winding of the two-phase motor; and a control block configured to switch the first switching device and the second switching device to selectively control current in the first and second phase windings. These and other aspects of the present disclosure are described below with the aid of the accompanying drawings.

In accordance with certain exemplary implementations of the disclosed technology, another two-phase motor driver circuit is disclosed herein, which can include a load terminal configured to connect with an alternating current (AC) load line; a neutral terminal connected to a ground, the neutral terminal configured to connect with an AC neutral line; a first load rectifier having an anode and a cathode, wherein the anode is connected to the load terminal; a first load rectifier capacitor having a first end connected to the cathode of the first load rectifier and a second end connected to the ground; a second load rectifier having an anode and a cathode, wherein the cathode is connected to the load terminal; a second load rectifier capacitor having a first end connected to the anode of the second load rectifier and a second end connected to the ground; a first switching device having an input terminal, an output terminal, and a switching control terminal, wherein the input terminal is connected to the cathode of the first load rectifier; a second switching device having an input terminal, an output terminal, and a switching control terminal, wherein the input terminal is connected to the anode of the second load rectifier; a third switching device having an input terminal, an output terminal, and a switching control terminal, wherein the input terminal is connected to the cathode of the first load rectifier; a fourth switching device having an input terminal, an output terminal, and a switching control terminal, wherein the input terminal is connected to the anode of the second load rectifier; a first motor terminal connected to the output terminal of the first switching device and the output terminal of the second switching device, wherein the first motor terminal is configured to connect with a first end of a first phase winding of a two-phase motor; a second motor terminal connected to the output terminal of the third switching device and the output terminal of the fourth switching device, wherein the second motor terminal is configured to connect with a first end of a second phase winding of the two-phase motor; a third motor terminal connected to the ground and configured to connect to a second end of the first phase winding of the two-phase motor and a second end of the second phase winding of the two-phase motor; and a control block having independent connections to each switching control terminal and configured to selectively switch the first switching device, the second switching device, the third switching device, and the fourth switching device to selectively control current in the first and second phase windings.

In certain implementations, the above-reference two-phase motor driver circuits may be disposed on a first printed circuit board (PCB) and the first phase winding and the second phase winding of the two-phase motor may disposed on the first PCB such that the driver circuit and at least a stator of the two-phase motor are integrated on the same first PCB.

Certain implementations of the disclosed technology include a method of providing a PCB stator having a plurality of PCB stator cores distributed about a hole centered on a central rotational axis, each of the PCB stator cores comprising at least one stator coil layer surrounding a corresponding core; installing driver circuitry on the same PCB as the PCB stator; inserting a common shaft through the hole centered on the rotational axis of the PCB; attaching one or more rotors to the common shaft, each of the one or more rotors comprising at least two magnetic poles; and securing the PCB stator to a frame having at least one bearing, wherein the frame is configured to align and support the one or more rotors for rotation about the central rotational axis.

Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods.

### BRIEF DESCRIPTION OF THE DRAWINGS

The following detailed description of specific embodiments of the disclosure will be better understood when read in conjunction with the appended drawings. For the purpose of illustrating the various implementations, specific embodiments are shown in the drawings. It should be understood, however, that the disclosure is not limited to the precise arrangements and instrumentalities of the embodiments shown in the drawings, and the drawings are not necessarily to scale.

FIG. 1 is an example circuit diagram of a split neutral, two-phase motor driver, in accordance with an exemplary embodiment of the disclosed technology.

FIG. 2 is an example circuit diagram of another two-phase motor driver, in accordance with an exemplary embodiment of the disclosed technology.

FIG. 3 is an example top-view illustration of combined driver circuitry and PCB stator assembly formed using the same PCB in which windings of the stator cores may be formed using circuit-trace-based spiral-like stator windings around central cores, and for which various interconnecting traces (not shown) may be routed from the driver circuitry to the stator windings using low-cost PCB fabrication methods. In certain implementations, vias may be utilized to route driver current to the trace windings from another side or layer of the PCB and/or to connect to additional co-aligned stator cores defined in different layers of the PCB and/or via stacked PCBs.

FIG. 4 depicts a 3D exploded view of portions of a single or dual-rotor axial flux motor, in accordance with certain exemplary implementations of the disclosed technology, where the rotors poles are made using low-cost ferromagnetic material, and where the driver circuitry may be integrated with the stator or separate from the stator.

FIG. 5 depicts a 3D exploded view of portions of an example axial flux motor where the PCB may have additional thru-holes for mounting a frame and/or a back-iron, in accordance with certain exemplary implementations of the disclosed technology.

FIG. 6 is a flow-diagram of an example method, in accordance with certain exemplary implementations of the disclosed technology.

The above-reference figures are intended to assist in understanding the example implementations but are not intended to limit the scope to the illustrated elements. Like reference numbers may indicate identical or functionally similar elements.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Certain implementations of the disclosed technology include simplified motor driver designs that can reduce manufacturing costs. Certain implementations of the disclosed technology can be particularly well matched for use in two-phase motors, such as axial-flux motors the utilize one or more ferrite-based rotors and a printed circuit board (PCB)-based stator. In accordance with certain exemplary implementations of the disclosed technology, part or all of the motor driver circuitry may be integrated onto the same PCB as is utilized to define the stator windings. In other implementations, the motor driver circuitry may be independently utilized with other traditional electrical motors.

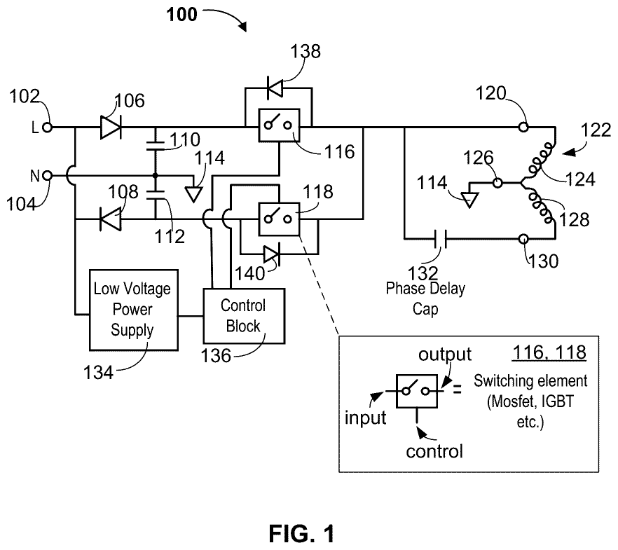

FIG. 1 is an example block diagram of two-phase motor driver circuitry 100, in accordance with an exemplary embodiment of the disclosed technology. The circuitry 100 is illustrated as split-neutral that can source power from an alternating current (AC) load line with a neutral return. Certain implementations of the disclosed technology can include a load terminal 102 configured to connect with the alternating current (AC) load line. The circuitry 100 can include a neutral terminal 104 connected to a ground 114, wherein the neutral terminal 104 is further configured to connect with an AC neutral line. The circuitry 100 can include a first load rectifier 106 having an anode and a cathode, wherein the anode is connected to the load terminal 102. The circuitry 100 can include a first load rectifier capacitor 110 having a first end connected to the cathode of the first load rectifier 106 and a second end connected to the ground 114. The circuitry 100 can include a second load rectifier 108 having an anode and a cathode, wherein the cathode is connected to the load terminal 102. The circuitry 100 can include a second load rectifier capacitor 112 having a first end connected to the anode of the second load rectifier 108 and a second end connected to the ground 114. The circuitry 100 can include a first switching device 116 having an input terminal, an output terminal, and a switching control terminal as indicated in the inset box. In accordance with certain exemplary implementations of the disclosed technology, the input terminal of the first switching device 116 may be connected to the cathode of the first load rectifier 106. The circuitry 100 can include a second switching device 118 having an input terminal, an output terminal, and a switching control terminal. The input terminal of the second switching device 118 may be connected to the anode of the second load rectifier 108.

The circuitry 100 can include a first motor terminal 120 connected to the output terminal of the first switching device 116 and the output terminal of the second switching device 118. In certain implementations, the first motor terminal 120 is configured to connect with a first end of a first phase winding 124 of a two-phase motor 122, and a second motor terminal 130 configured to connect with a first end of a second phase winding 128 of the two-phase motor 122. In certain implementations, a phase delay capacitor 132 having a first end and a second end may have the first end connected to the first motor terminal 120 and the second end connected to the second motor terminal 130. In certain implementations, the phase delay capacitor 132 may act as starting capacitor to lag the current in the second phase winding 128. The circuitry 100 can include a third motor terminal 126 connected to the ground 114 and configured to connect to a second end of the first phase winding 124 of the two-phase motor 122 and a second end of the second phase winding 128 of the two-phase motor 122.

In accordance with certain exemplary implementations of the disclosed technology, the circuitry 100 can include a control block 136 configured to switch the first switching device 116 and/or the second switching device 118 to selectively control current in the first phase winding 124 and the second phase winding 128.

As indicated in FIG. 1, certain implementations of the circuitry 100 can include first back EMF diode 138 having an anode connected to the output terminal of the first switching device 116 and a cathode connected to the input terminal of the first switching device 116. The circuitry 100 can include a second back EMF diode 140 having an anode connected to the input terminal of the second switching device 118 and a cathode connected to the output terminal of the second switching device 118.

In certain implementations, the circuitry 100 can further include a low voltage power supply 134 configured to receive power from the load terminal and to provide low voltage power to the control block 136.

In certain implementations, one or more of the first switching device 116 and the second switching device 118 can be one or more of an insulated gate bipolar transistor (IGBT), a metal oxide semiconductor field effect transistor (MOSFET), or the like.

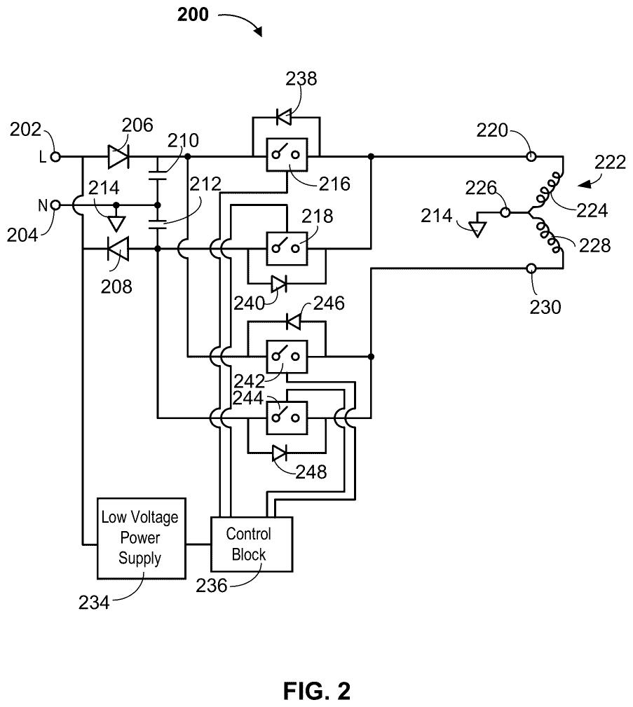

FIG. 2 is an example circuit diagram of similar two-phase motor driver circuitry 200, in accordance with an exemplary embodiment of the disclosed technology.

The circuitry 200 can include a load terminal 202 configured to connect with an alternating current (AC) load line. The circuitry 200 can include a neutral terminal 204 connected to a ground 214. In certain implementations, the neutral terminal 204 may be configured to connect with an AC neutral line. The circuitry 200 can include a first load rectifier 206 having an anode and a cathode, wherein the anode may be connected to the load terminal 202. The circuitry 200 can include a first load rectifier capacitor 210 having a first end connected to the cathode of the first load rectifier 206 and a second end connected to the ground 214. The circuitry 200 can include a second load rectifier 208 having an anode and a cathode, wherein the cathode may be connected to the load terminal 202. The circuitry 200 can include a second load rectifier capacitor 212 having a first end connected to the anode of the second load rectifier 208 and a second end connected to the ground 214.

The circuitry 200 can include a first switching device 216 having an input terminal, an output terminal, and a switching control terminal, wherein the input terminal may be connected to the cathode of the first load rectifier 206. The circuitry 200 can include a second switching device 218 having an input terminal, an output terminal, and a switching control terminal, wherein the input terminal may be connected to the anode of the second load rectifier 208. The circuitry 200 can include a third switching device 242 having an input terminal, an output terminal, and a switching control terminal, wherein the input terminal may be connected to the cathode of the first load rectifier 206. The circuitry 200 can include a fourth switching device 244 having an input terminal, an output terminal, and a switching control terminal, wherein the input terminal may be connected to the anode of the second load rectifier 208

The circuitry 200 can include a first motor terminal 220 connected to the output terminal of the first switching device 216 and to the output terminal of the second switching device 218. The first motor terminal may be configured to connect with a first end of a first phase winding 224 of a two-phase motor 222. The circuitry 200 can include a second motor terminal 230 connected to the output terminal of the third switching device 242 and to the output terminal of the fourth switching device 244. In certain implementations, the second motor terminal 230 may be configured to connect with a first end of a second phase winding 228 of the two-phase motor 222. The circuitry 200 can include a third motor terminal 226 connected to the ground 214 and configured to connect to a second end of the first phase winding 224 of the two-phase motor 222 and a second end of the second phase winding 228 of the two-phase motor 222.

Certain implementations of the disclosed technology include a control block 236 having independent connections to each switching control terminal of the switching devices 216, 218, 242, 244 and may be configured to selectively switch the first switching device 216, the second switching device 218, the third switching device 242, and the fourth switching device 244 to selectively control current in the first phase winding 224 and/or the second phase winding 228 of the two-phase motor 222.

As indicated in FIG. 2, certain implementations of the circuitry 200 can include first back EMF diode 238 having an anode connected to the output terminal of the first switching device 216 and a cathode connected to the input terminal of the first switching device 216. The circuitry 200 can include a second back EMF diode 240 having an anode connected to the input terminal of the second switching device 218 and a cathode connected to the output terminal of the second switching device 218. The circuitry 200 can include third back EMF diode 246 having an anode connected to the output terminal of the third switching device 242 and a cathode connected to the input terminal of the third switching device 242. The circuitry 200 can include a fourth back EMF diode 248 having an anode connected to the input terminal of the fourth switching device 244 and a cathode connected to the output terminal of the fourth switching device 244.

In certain implementations, the circuitry 200 can further include a low voltage power supply 234 configured to receive power from the load terminal 202 and to provide low voltage power to the control block 236.

In certain implementations, one or more of the first switching device 216, the second switching device 218, the third switching device 242, and/or the fourth switching device 244 can be one or more of an insulated gate bipolar transistor (IGBT), a metal oxide semiconductor field effect transistor (MOSFET), or the like.

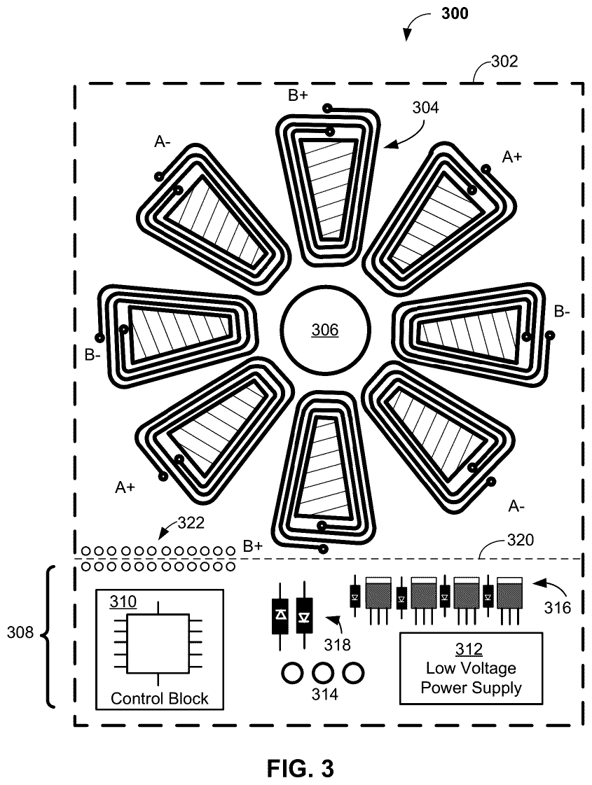

FIG. 3 is an example top-view illustration of combined driver circuitry and PCB stator assembly 300 formed using the same PCB stator assembly 302 in which windings of the stator cores 304 may be formed using circuit-trace-based spiral-like stator windings around central cores, and for which various interconnecting traces (not shown) may be routed from the driver circuitry 308 to the windings of the stator cores 304 using low-cost PCB fabrication methods. In certain implementations, vias may be utilized to route driver current to the trace windings from another side and/or layer of the PCB 302 and/or to connect to additional co-aligned stator cores defined in different layers of the PCB 302 and/or via stacked PCBs.

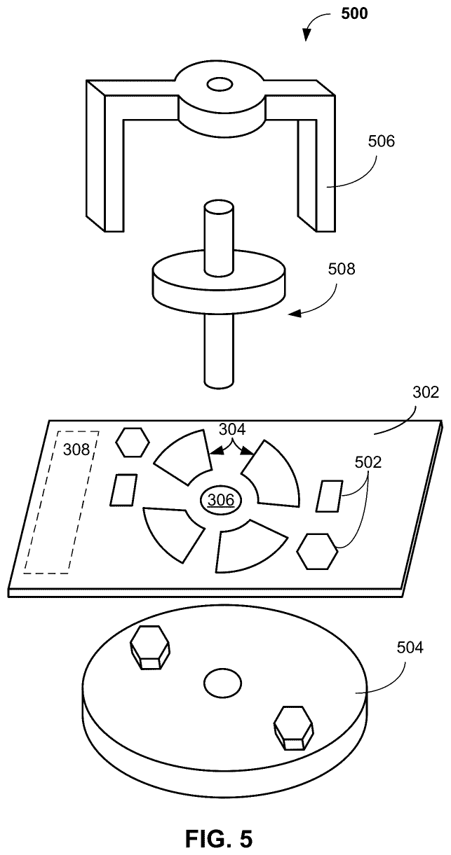

FIG. 3 depicts a two-phase (A, B), four pole (A+, A−, B+, B−) stator with eight cores distributed around a central rotor hole 306 (concentric with a rotor rotational axis) for illustration only and should not be considered as limiting the arrangement of the stator or associated components. Furthermore, in certain implementations, the various components of the driver circuitry 308, such as the control block 310, the low voltage power supply 312, the terminals 314, the rectifier diodes 318, and/or the switching devices 316 may be disposed at different locations on the PCB 302, on a different side of the PCB. For example, In certain implementations, one or more of the components of the driver circuitry 308 may be disposed in areas on the PCB 302 between or surrounding the stator cores 304 as needed to provide a compact stator that can be packaged with an enclosure, frame, back iron, etc. as will be discussed below with reference to FIG. 5

As discussed above, the two-phase motor driver circuitry 308 may be disposed on a common PCB with the stator of the two-phase motor. However, in certain implementations in which it is desired to have the driver circuitry 308 separated 320 from the rest of the PCB 302, interconnection holes/pads 322 may be defined in each section to facilitate connecting the driver circuitry 308 to the appropriate windings of the stator, either by jumper wire, connectors, ribbon cable, etc. In such implementations, even if the finished motor does not have the driver circuitry 308 integrated onto the PCB stator assembly 302, there may still be manufacturing cost savings and/or other benefits. Therefore, In certain implementations, the driver circuitry may be disposed on a first PCB, stator windings may be disposed on a second PCB.

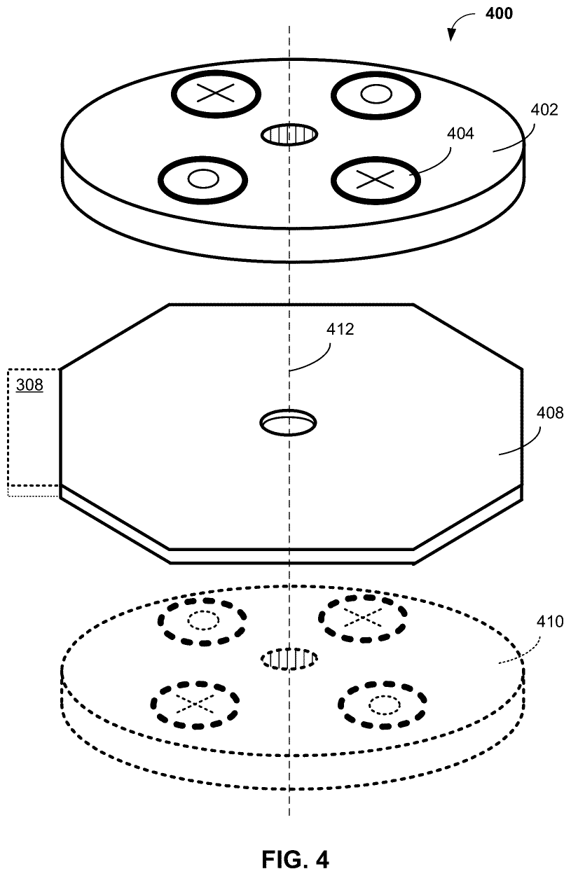

FIG. 4 depicts a 3D exploded view of portions of a single rotor 402 or dual-rotor (402, 410) axial flux motor 400, in accordance with certain exemplary implementations of the disclosed technology, where the rotors poles 404 may be made using low-cost ferromagnetic material, and where the driver circuitry 308 may be integrated with the PCB stator assembly 408 (such as the PCB stator assembly 300 discussed above with respect to FIG. 3) or separate from the PCB stator assembly 408. In this illustration, the individual cores and components of the PCB stator assembly 408 plus a rotor shaft, mounting frame, etc., are omitted for clarity. As illustrated, the axial flux motor 400 can include a first rotor 402 disposed adjacent to a first side of the PCB stator assembly 408. In certain implementations, a second rotor 410 may be disposed adjacent to a second side of the PCB stator assembly 408. In certain implementations, a dual stator assembly may be utilized (not shown) wherein a rotor 402 may be disposed between two stator assemblies.

FIG. 4 illustrates the alignment of the rotors 402 (and/or 410) with the central rotational axis 412 of the PCB stator assembly 408. In accordance with certain implementations of the disclosed technology, magnetic fields generated by the PCB stator assembly 408 may interact with magnetically charged poles 404 defined in the rotors 402, 410 to provide rotational torque on the rotors 402, 410 relative to the PCB stator assembly 408.

In accordance with certain exemplary implementations of the disclosed technology, the rotor poles 404 may be made by injection molded magnets made from particles of hard magnetic material. For example, injection molded magnets for the rotor poles 404 may be made from dense magnetic powders blended with a variety of polymer base materials as a binder. Depending on the combination of magnetic material and polymer selected, a wide range of final material properties and complex shapes are possible. The injection molded magnets may form simple shapes to very complex shapes. Depending on the magnetic material, the parts may require magnetic orientation during the injection molding process to optimize the magnetic properties. In accordance with certain exemplary implementations of the disclosed technology, injection molded magnets can be utilized in an overmolding process to define corresponding regions of poles 404 in the rotors 402, 410. In accordance with certain exemplary implementations of the disclosed technology, an overmold may be utilized to define and/or produce the other regions of rotor(s) so that the result is an integrated part.

FIG. 5 depicts a 3D exploded view of portions of an example axial flux motor assembly 500, where the PCB stator assembly 302 may have additional thru-holes 502 for mounting a frame/bearing assembly 506, for example, to secure/support one end of the rotor/shaft assembly 508 and/or a back iron 504 and/or associated bearings to secure/support the other end of the rotor/shaft assembly 508, in accordance with certain exemplary implementations of the disclosed technology. This embodiment may enable rapid construction of an axial flux motor attached to a PCB-based stator assembly 302, as discussed herein.

In certain implementations, the attachment of the frame/bearing assembly 506 and/or the back iron 504 and associated components to PCB stator assembly 302 may facilitate fabrication of a low-cost single motor product and/or as a PCB-mounted motor within a greater PCB assembly. This design allows for low-cost micromotors, for example, to be placed directly on a PCB without requiring the expense of additional mounting hardware. This design also may simplify the positioning/alignment of the various motor components. The implementations discussed above in reference to FIG. 5 may be utilized with the other implementations discussed herein.

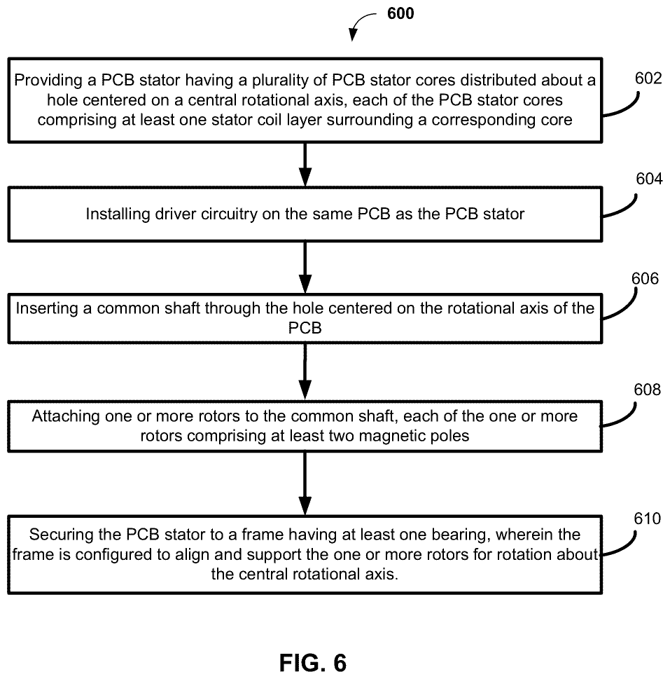

FIG. 6 is a flow-diagram of an example method 600 of manufacturing an axial flux motor having a PCB-based stator assembly, in accordance with certain exemplary implementations of the disclosed technology. In block 602, the method 600 providing a PCB stator having a plurality of PCB stator cores distributed about a hole centered on a central rotational axis, each of the PCB stator cores comprising at least one stator coil layer surrounding a corresponding core. In block 604, the method 600 includes installing driver circuitry on the same PCB as the PCB stator. In block 606, the method 600 includes inserting a common shaft through the hole centered on the rotational axis of the PCB. In block 608, the method 600 attaching one or more rotors to the common shaft, each of the one or more rotors comprising at least two magnetic poles. In block 610, the method 600 includes securing the PCB stator to a frame having at least one bearing, wherein the frame is configured to align and support the one or more rotors for rotation about the central rotational axis.

In accordance with certain exemplary implementations of the disclosed technology the stator cores of the PCB stator assembly may be formed using circuit-trace-based spiral-like stator windings. In certain implementations, central thru-voids may be defined within each stator winding in which core inserts comprising steel layers may be inserted. The windings and associated traces may be formed on the PCB, for example, using standard printed circuit board manufacturing techniques. In certain implementations, each end of each stator winding conductors may be routed to driver circuitry that may be used to induce magnetic fields via current running through the trace windings. In certain implementations, vias may be utilized to route such driver current to the trace windings from another side or layer of the PCB and/or to connect to additional co-aligned stator cores defined in different layers of the PCB and/or via stacked PCBs.

In accordance with certain exemplary implementations of the disclosed technology, the thru-voids in the PCB can be machined either before or after etching the circuit traces, for example, to facilitate disposing stator core inserts in the corresponding thru-voids in the PCB, for example, to enable boosting/concentrating of the magnetic flux generated by the PCB stator assembly. In certain implementations, the stator core inserts can include interior space that may be filled using silicon steel or other soft ferromagnetic material to provide a core that may increase the magnetic flux strength while reducing eddy currents.

It should also be appreciated that the utilization of the stator core inserts in the stator may provide many advantages over designs that utilize insertable cores in a rotor because the stator is stationary, and not subject to the same rotational forces as experience by a rotor. Thus, in contrast to designs that may utilize insertable cores in a rotor, the disclosed technology may allow for relaxed tolerances on the requirements for exact equidistant positioning and/or requirements for exact equal weights of the inserts (for balancing to avoid vibrations). Furthermore, in certain implementations, interference fitting or other “snap-in” techniques may be utilized in the disclosed technology to secure the inserts in the stator cores while relaxing tolerances of a thermal expansion match with the PCB.

In certain implementations, one or more of the components disclosed herein be manufactured by an overmolding process. Overmolding, for example, can include a process in which a material (such as a plastic) is molded over another part, which may also be molded. In certain implementations, the overmolding can be a two-shot process that involves injecting two different materials to form a substrate and an overmold.

In accordance with certain exemplary implementations of the disclosed technology, a soft magnetic composite (SMC) powder may be utilized to fabricate the stator core insert (and/or poles of the rotor). SMC material, for example, can provide a lower cost alternative to stacked laminations. SMC's can be created by coating individual particles of iron with an insulation material. In certain implementations, injection molded magnets formed from dense magnetic powders blended with a variety of polymer base materials as a binder may be utilized. In certain implementations, overmolding may be utilized. By providing an insulation prior to forming a stator core insert (and/or rotor pole) the result is a component that can have high-resistivity and very little eddy current losses. Coupling the material capabilities with the design freedom of conventional powder metallurgy, the various components of the axial flux motor, can be designed to guide the magnetic flux taking advantage of 3D vertical architecture in accordance with certain exemplary implementations of the disclosed technology.

In accordance with certain exemplary implementations of the disclosed technology, the rotor poles may be made by injection molded magnets made from particles of hard magnetic material. For example, injection molded magnets for the rotor poles may be made from dense magnetic powders blended with a variety of polymer base materials as a binder. Depending on the combination of magnetic material and polymer selected, a wide range of final material properties and complex shapes are possible. The injection molded magnets may form simple shapes to very complex shapes. Depending on the magnetic material, the parts may require magnetic orientation during the injection molding process to optimize the magnetic properties. In accordance with certain exemplary implementations of the disclosed technology, injection molded magnets can be utilized in an overmolding process to define corresponding regions of poles in the rotors. In accordance with certain exemplary implementations of the disclosed technology, an overmold may be utilized to define and/or produce the other regions of rotor(s) so that the result is an integrated part that does not suffer from negative issues that can be associated with inserts attached to such rotating parts.

The disclosed technology enables implementation of small PCB-based motor using a two-phase design, thus allowing for the use of low cost driver circuitry powered by a battery, a rectified AC power supply, and/or a DC power supply. As disclosed herein, certain implementations may utilize a PCB stator to further reduce costs. Additionally, the integration of the low-cost driver circuitry on the same substrate as the PCB stator may further reduce costs, and may be appropriate for a wide range of small motors.

In a typical two-phase induction motor, a sine wave may be applied to the phases, which can enable the induction motor to be self-starting. For the 2 phase PCB motor disclosed herein to self-start, an induction style rotor may be used. In contrast, the typical PCB construction involves a single or dual rotor with permanent magnets affixed to a shaft creating a synchronous motor that needs starting circuitry. Either the asynchronous or synchronous embodiment of the 2 phase PCB motor typically requires circuitry to generate the needed sine wave. However, the disclosed technology may enable the motor to self-start without the need for detecting position. In certain implementations, management of the power to the phases could be achieved by using a capacitor and H-bridge with a DC power source in its simplest forms, though more complex embodiments are possible to enable more features and performance. Certain implementations may utilize an oscillator capable of generating startup drive signals and/or shaped drive signals/frequencies for being supplied to the stator windings. In yet other embodiments, the driver circuitry may include a starter circuit which may start the rotation, then hand-off driver control for ongoing operation utilizing an auxiliary detection winding or Hall sensor.

Certain implementations of the disclosed technology may enable or allow the operation of the driver circuitry and/or the associated PCB stator motor without requiring one or more of: H-bridges, firmware, pulse-width-modulation (PWM) circuitry, position sensor (such as a Hall sensor or other rotor positioning indication mechanism) closed loop feedback (such as a PID controller), switching power supplies, isolated grounds, heat sinks, separate circuit boards, separate housings, additional wiring, etc., each of which can drive up the costs.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

What is claimed is:

1. A two-phase motor driver circuit, comprising:
a load terminal configured to connect with an alternating current (AC) load line;
a neutral terminal connected to a ground, wherein the neutral terminal is further configured to connect with an AC neutral line;
a first load rectifier having an anode and a cathode, wherein the anode is connected to the load terminal;
a first load rectifier capacitor having a first end connected to the cathode of the first load rectifier and a second end connected to the ground;
a second load rectifier having an anode and a cathode, wherein the cathode is connected to the load terminal;
a second load rectifier capacitor having a first end connected to the anode of the second load rectifier and a second end connected to the ground;
a first switching device having an input terminal, an output terminal, and a switching control terminal, wherein the input terminal is connected to the cathode of the first load rectifier;
a second switching device having an input terminal, an output terminal, and a switching control terminal, wherein the input terminal is connected to the anode of the second load rectifier;
a first motor terminal connected to the output terminal of the first switching device and the output terminal of the second switching device, wherein the first motor terminal is configured to connect with a first end of a first phase winding of a two-phase motor;
a second motor terminal configured to connect with a first end of a second phase winding of the two-phase motor;
a phase delay capacitor having a first end and a second end, wherein the first end is connected to the first motor terminal and the second end is connected to the second motor terminal;
a third motor terminal connected to the ground and configured to connect to a second end of the first phase winding of the two-phase motor and a second end of the second phase winding of the two-phase motor; and
a control block configured to switch the first switching device and the second switching device to selectively control current in the first and second phase windings.

2. The two-phase motor driver circuit of claim 1, further comprising:
a first back EMF diode having an anode connected to the output terminal of the first switching device and a cathode connected to the input terminal of the first switching device; and
a second back EMF diode having an anode connected to the input terminal of the second switching device and a cathode connected to the output terminal of the second switching device.

3. The two-phase motor driver circuit of claim 1, further comprising a low voltage power supply configured to receive power from the load terminal and to provide low voltage power to the control block.

4. The two-phase motor driver circuit of claim 1, wherein one or more of the first switching device and the second switching device comprise one or more of a insulated gate bipolar transistor (IGBT) and a metal oxide semiconductor field effect transistor (MOSFET).

5. The two-phase motor driver circuit of claim 1, wherein the two-phase motor driver circuit is disposed on a first printed circuit board (PCB) and the first phase winding and the second phase winding of the two-phase motor are disposed on the first PCB such that the driver circuit and at least a stator of the two-phase motor are integrated on the same first PCB.

6. The two-phase motor driver circuit of claim 1, wherein the two-phase motor driver circuit is disposed on a first printed circuit board (PCB) and the first phase winding and the second phase winding of the two-phase motor is disposed on a second PCB.

7. The two-phase motor driver circuit of claim 1, wherein the control block is configured to switch the first switching device and the second switching device to selectively control current in the first and second phase windings in open loop.

8. The two-phase motor driver circuit of claim 1, wherein the two-phase motor comprises an axial flux motor.

9. The two-phase motor driver circuit of claim 1, wherein the two-phase motor comprises a radial flux motor.

10. The two-phase motor driver circuit of claim 1, wherein the two-phase motor comprises:
a printed circuit board (PCB) stator assembly having a plurality of PCB stator cores distributed about a central rotational axis, each of the PCB stator cores comprising at least one stator coil layer surrounding a corresponding a stator core.

11. A two-phase motor driver circuit, comprising:
a load terminal configured to connect with an alternating current (AC) load line;
a neutral terminal connected to a ground, the neutral terminal configured to connect with an AC neutral line;
a first load rectifier having an anode and a cathode, wherein the anode is connected to the load terminal;
a first load rectifier capacitor having a first end connected to the cathode of the first load rectifier and a second end connected to the ground;
a second load rectifier having an anode and a cathode, wherein the cathode is connected to the load terminal;
a second load rectifier capacitor having a first end connected to the anode of the second load rectifier and a second end connected to the ground;
a first switching device having an input terminal, an output terminal, and a switching control terminal, wherein the input terminal is connected to the cathode of the first load rectifier;
a second switching device having an input terminal, an output terminal, and a switching control terminal, wherein the input terminal is connected to the anode of the second load rectifier;
a third switching device having an input terminal, an output terminal, and a switching control terminal, wherein the input terminal is connected to the cathode of the first load rectifier;
a fourth switching device having an input terminal, an output terminal, and a switching control terminal, wherein the input terminal is connected to the anode of the second load rectifier;
a first motor terminal connected to the output terminal of the first switching device and the output terminal of the second switching device, wherein the first motor terminal is configured to connect with a first end of a first phase winding of a two-phase motor;
a second motor terminal connected to the output terminal of the third switching device and the output terminal of the fourth switching device, wherein the second motor terminal is configured to connect with a first end of a second phase winding of the two-phase motor;
a third motor terminal connected to the ground and configured to connect to a second end of the first phase winding of the two-phase motor and a second end of the second phase winding of the two-phase motor; and
a control block having independent connections to each switching control terminal and configured to selectively switch the first switching device, the second switching device, the third switching device, and the fourth switching device to selectively control current in the first and second phase windings.

12. The two-phase motor driver circuit of claim 11, further comprising:
a first back EMF diode having an anode connected to the output terminal of the first switching device and a cathode connected to the input terminal of the first switching device;
a second back EMF diode having an anode connected to the input terminal of the second switching device and a cathode connected to the output terminal of the second switching device;
a third back EMF diode having an anode connected to the output terminal of the third switching device and a cathode connected to the input terminal of the third switching device; and
a fourth back EMF diode having an anode connected to the input terminal of the fourth switching device and a cathode connected to the output terminal of the fourth switching device.

13. The two-phase motor driver circuit of claim 11, further comprising a low voltage power supply configured to receive power from the load terminal and to provide low voltage power to the control block.

14. The two-phase motor driver circuit of claim 11, wherein one or more of the first switching device, the second switching device, the third switching device, and the fourth switching device comprise one or more of an insulated gate bipolar transistor (IGBT) and a metal oxide semiconductor field effect transistor (MOSFET).

15. The two-phase motor driver circuit of claim 11, wherein the two-phase motor driver circuit is disposed on a first printed circuit board (PCB) and the first phase winding and the second phase winding of the two-phase motor are disposed on the first PCB such that the driver circuit and at least a stator of the two-phase motor are integrated on the same first PCB.

16. The two-phase motor driver circuit of claim 11, wherein the two-phase motor driver circuit is disposed on a first printed circuit board (PCB) and the first phase winding and the second phase winding of the two-phase motor is disposed on a second PCB.

17. The two-phase motor driver circuit of claim 11, wherein the control block is configured to independently switch the first switching, the second switching device, the third switching device, and the fourth switching device to selectively control current in the first and second phase windings of the two-phase motor.

18. The two-phase motor driver circuit of claim 11, wherein the two-phase motor comprises an axial flux motor.

19. The two-phase motor driver circuit of claim 11, wherein the two-phase motor comprises a radial flux motor.

20. The two-phase motor driver circuit of claim 11, wherein the two-phase motor comprises: a printed circuit board (PCB) stator assembly having a plurality of PCB stator cores distributed about a central rotational axis, each of the PCB stator cores comprising at least one stator coil layer surrounding a corresponding a stator core.
